(19) United States
(12) Patent Application Publication
(10) Pub. No.: US 2006/0053986 A1
(43) Pub. Date: Mar. 16, 2006

(54) Screw driver with bit storage cylinder

(76) Inventor: Russell G. Ward, Long Beach, CA (US)

Correspondence Address: James D. Givnan, Jr, 8175 S. W. Ernst Road, Portland, OR, 97225, US

(21) Appl. No.: 10/939,287

(22) Filed: Sep. 13, 2004

(51) Int. Cl. B25G 1/08

(52) U.S. Cl. 81/490

(57) ABSTRACT

A base carries a positionable hand grip. A cylinder is rotatably mounted on the base and carries multiple bits for driving various types of fasteners. An ejector rod on the base propels a selected bit from the cylinder through a drive tube to an exposed position. A base carried spindle imparts rotational movement to drive component and the drive tube. Magnetic components assist in positioning and retention of the screw driver bits.

### BACKGROUND OF THE INVENTION

The present invention concerns tools having the capability of storing a collection of bits individually insertable into a drive component for driving of a threaded fastener.

In the prior art are hand tools which have a hand grip having receptacles spaced thereabout in which screw driver bits of different sizes and shapes may be stored to provide the tool user with a selection for different fastener recesses. Such tools rely on manual removal of a bit from its receptacle, grasping of the bit end and installing the bit in the end of a member. Such hand tools may include a ratchet drive. When a number of different fastener types are to be driven the worker must individually remove a used bit which is then manually returned to a storage receptacle in the handle. As such fastener driving bits are quite small, the tasks require care in installation as well as in removal from a drive member.

### SUMMARY OF THE PRESENT INVENTION

The present invention is embodied within a tool having an array of driver bits stowed therein with provision made for selection of a bit and subsequent repositioning of the bit in an operable position at the end of a drive.

A main body member of the tool supports a bit storage cylinder. Each bit receptacle in the cylinder is rotatably positionable into alignment with a drive tube for subsequent positioning therethrough by an ejector carried by the base. Rectilinear positioning of the ejector ejects the driver bit for use and retracts the bit into a storage receptacle. A multipositionable handle or hand grip is swingably mounted onto the base and is positionable for use as a hand grip during driving of a fastener. The hand grip imparts rotational movement to the base and a base mounted spindle and ultimately the drive tube on which a bit is installed.

Important objectives of the present tool is the storage capacity of a fastener driving tool to provide an array of different assortment of driving bits which are readily positioned for use as well as being readily retrieved to a storage receptacle in the tool; the provision of a hand tool having a multipositionable handle having both a stowed position as well as a first operable wherein the handle or hand grip acts as a stop for an ejector and a second operable position for imparting rotation to the bit retaining drive tube; the provision of a tool having a magnetic member to retract a driver bit into a storage receptacle; the provision of a hand tool which may be used, in optionable fashion, as a screwdriver driving a driver bit in an incremental or ratchet fashion.

### BRIEF DESCRIPTION OF THE DRAWINGS

In the accompanying drawings:

FIG. 1 is an elevational view of the present tool;

FIG. 2A is plan view thereof;

FIG. 2B is a plan view thereof with parts repositioned from FIG. 2A;

FIG. 3 is a side elevational view of an ejector rod of the present tool;

FIG. 4 is a sectional view taken along line 4-4 of FIG. 1;

FIG. 5 is a sectional view taken along line 5-5 of FIG. 1;

FIGS. 6 and 7 are similar to FIG. 5 but showing different settings of a ratchet component;

FIG. 8 is a fragmentary elevational view of the present tool in modified form;

FIG. 9A is a fragmentary elevational view of a further modified form of the tool; and

FIG. 9B is a view similar to FIG. 9A but with an ejector rod retracted.

FIG. 10 is a view similar to FIG. 4 but showing modified bit retention means.

### DETAILED DESCRIPTION OF THE PREFERRED EMBODIMENTS

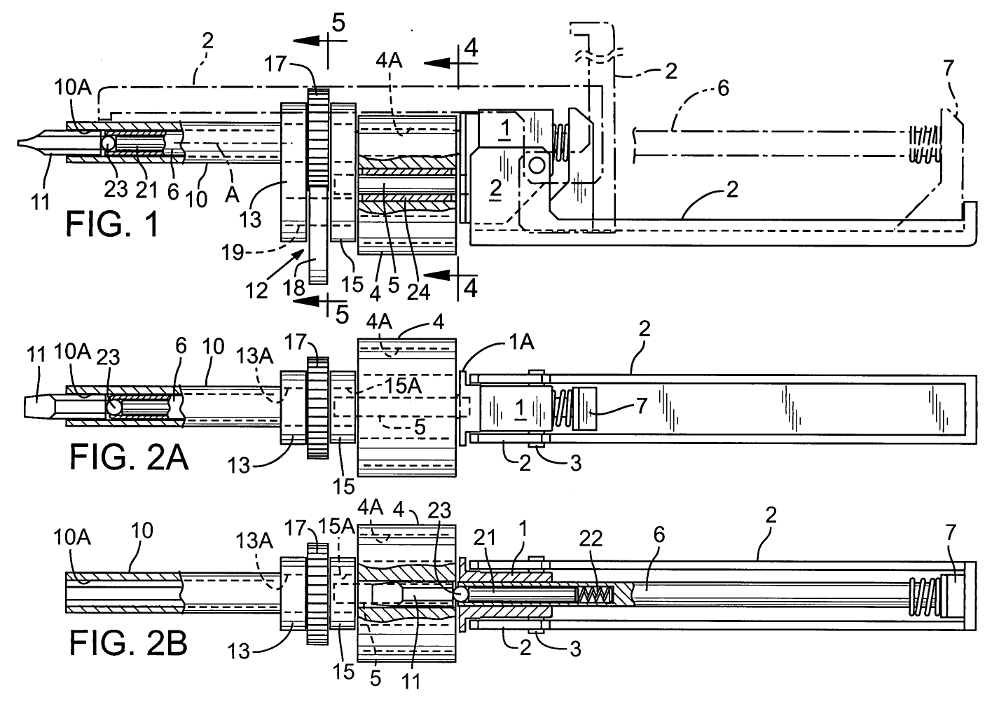

With continuing attention to the drawings, the reference numeral 1 indicates a main body of block shape which swingably carries a handle 2 positionable about a pivot pin 3. Flanges as at 1A limit handle travel to the position shown in FIG. 1. Projecting forwardly from a wall of base 1 is a spindle 5 which carries a cylinder 4. Cylinder 4 defines openings 4A in the manner of a revolver cylinder as shown in FIG. 4 with each opening receiving a driver bit 11 of a different size or type, e.g., Phillips, blade, hex, etc. The cylinder is disposed about a central magnetic sleeve which serves to retain each bit within its opening until ejected as later explained.

Drive means, indicated generally at 12, serve to impart rotation to a bit drive tube 10. Arms at 13 and 15 receive drive tube 10 inner end in journaled manner and allow rotational movement between the arms and drive tube while retaining the tube end. Carried by the arms and a pivot pin 19 is a pawl 18 as best shown in FIGS. 5 and 6. Pawl 18 is manually settable to engage a ratchet wheel 17 affixed to drive tube 10. Pawl 18 is carried by a cross-member at 19. From the foregoing it will be seen that positioning of handle or hand grip 2 to a position perpendicular to an axis A of the drive tube, as shown in FIG. 1 in broken lines, orbital movement may be imparted to spindle 5, which in turn swings plates 13 and 15 about axis A. Pawl 18, previously positioned relative wheel 17 for a driving operation, will move about axis A to drive wheel 17 and drive tube 10 in a fastener driving task. FIG. 5 shows pawl 18 imparting clockwise rotation to wheel 17 for clockwise step-like rotation of the drive tube. Drive tube 10 has a hexagonal bore enabling a selection and use of various bits with hexagonal walls.

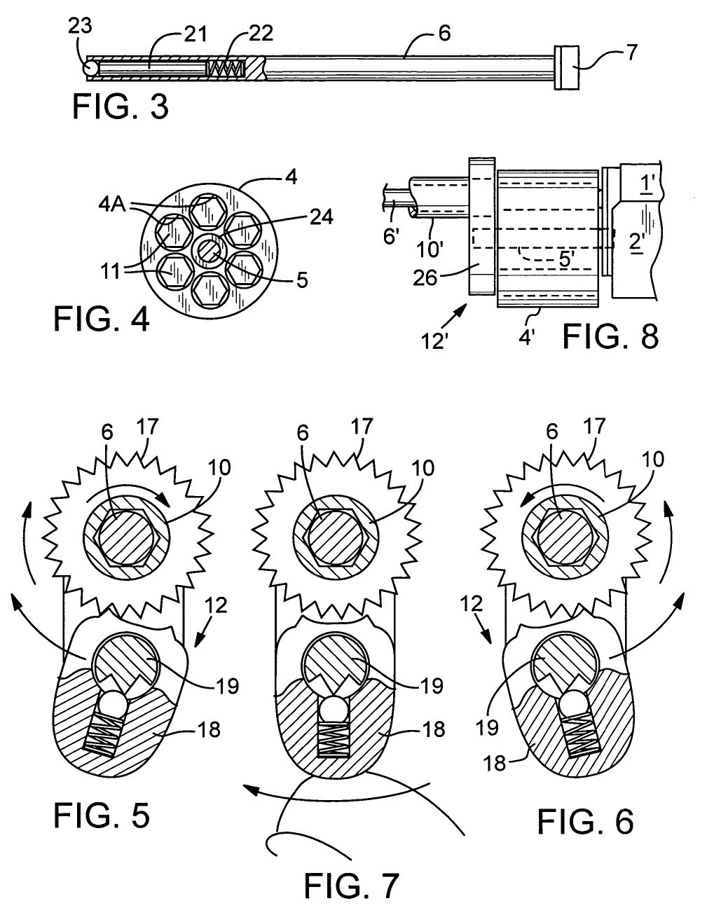

With attention to FIG. 3 of the drawings, an ejector assembly is shown which serves to eject a selected bit from cylinder 4 to the end of drive tube 10 for driving a fastener in either direction of rotation. The ejector assembly includes a rod 6 with a finger grip at 7. A magnetic member 21 is biased by a spring 22. Magnet 21 is confined by a captured ball 23 in the rod end. Magnet 21 and ball 23 enable retraction of a bit 11 back to cylinder 4. Ball 23, upon rod retraction, serves as a detent acting on cylinder 4. A magnetic sleeve 24 centrally disposed in the cylinder provides retention of bits stowed in their respective openings 4A.

In FIG. 10 a modified bit retainer is indicated generally at 35 and includes flexible, curved spring fingers 36, each finger projecting from a ring 37 lengthwise along an opening 4A in cylinder 4 to frictionally engage and retain a bit in place until acted on by ejector rod 6.

In operation, handle 2 is opened up to the full line position in FIG. 1, the finger grip 7 grasped to extract ejector rod 6 from tube 10 and from cylinder 4 to permit rotation of the latter to align a selected bit with ejector rod 6 which is then advanced to move the selected bit to the outer end of tube 10. Handle 2 is then swung 90 degrees to the broken line vertical position of FIG. 1 whereat it becomes a means of imparting rotation to base 1. Spindle 5 will orbit about axis A of drive tube 10 with the outer end of spindle 5 imparting motion to the joined drive plates 13 and 15 and to a pawl 18 to drive wheel 17 and the drive tube. Upon termination of driving a fastener, the ejector tube finger grip 7 is grasped and retracted toward the broken line position shown in FIG. 1, whereupon the magnetic body 21 will serve to return bit 11 to its cylinder receptacle. Should the user desire to drive a second fastener having a different head configuration, cylinder 4 is rotated to align another bit for driving the second fastener, whereupon ejector rod is again advanced from its broken line position of FIG. 1 forwardly to eject the selected bit from cylinder 4. Upon such advancement of ejector rod 6, the selected bit is positioned in a partially exposed manner at the drive tube end.

For storage of the present tool the ejector rod will be moved forwardly to the full line position of FIG. 1 permitting handle 2 to be swung fully about pin 3 into the broken line or stowed position adjacent the drive tube.

In FIG. 8 a modified form of the tool is shown wherein drive means at 12 dispenses with ratchet components. Earlier described corresponding parts are identified with prime reference numerals. Spindle 5′ drives an arm 26, secured to drive tube 10′.

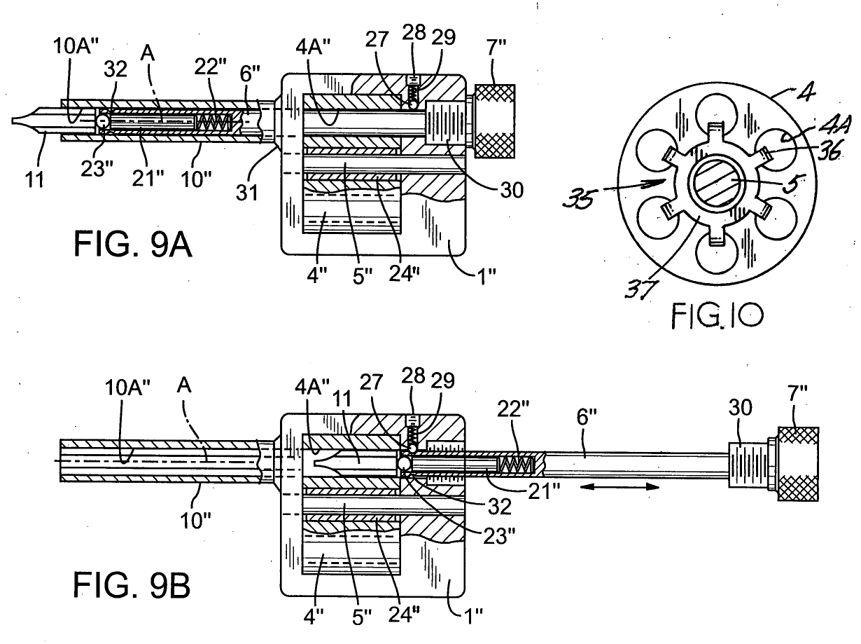

FIG. 9A discloses a further modified form of the present tool wherein double prime reference numerals indicate parts earlier identified with corresponding reference numerals. A drive tube 10″ is fixedly secured to a main body 1″ which is shaped to lend itself to be manually rotated about axis A of the drive tube. Cylinder 4″ is carried on spindle 5″ while an ejector assembly rod is at 6″ which is positioned in an operative position by a threaded segment 30 of a finger grip 7″. Rod 6″ serves as earlier described with partial extraction from main body 1″ permitting selected bit alignment with drive tube 10″

Drive means in this second modified form of the present invention is embodied in that structure such as a weld 31 securing drive tube 10″ to main body 1″. Drive means may be otherwise embodied as a threaded fastener securing the drive tube in place, the forming of the drive tube with at least one external planar wall for abutment with an internal walled opening in the main body, a set screw acting on the drive tube inserted end, a bonding agent between the drive tuve and main body, a lock nut on a threaded segment of the tube, to mention a few.

In FIG. 9B ejector rod 6″ is shown retracted preparatory to advancing a bit 11 toward the outer end of drive tube 10″. Rod retention means including a ball element 27, a spring 29 and a screw 28 serve to prevent accidental rod separation from main body 1″ by seating of the ball element in an annular groove 32 in the rod. Further, the retention means positions ball 23″, carried by the ejector rod, to act as a detent in locating a bit in alignment with the drive tube.

While I have shown but a few embodiments of the invention, it will be apparent to those skilled in the art that the invention may be embodied still otherwise without departing from the spirit and scope of the claimed invention.

Having thus described the invention, what is desired to be secured by a Letters Patent is:

I claim:

1. A screw driver with multiple bit storage comprising,
a main body with handgrip,
bit storage means for an array of bits for driving headed fasteners,
means on said main body movably mounting said bit storage means on said main body,
an ejector carried by said main body for displacing a bit from said bit storage means upon axial alignment of bit and ejector,
a drive tube for reception of a bit ejected to position the bit in an exposed manner, and
drive means for imparting rotation to the drive tube and a bit carried thereby upon arcuate movement of said main body and hand grip about the drive tube axis.

2. The screw driver claimed in claim 1 wherein said drive means includes a pawl and a ratchet wheel.

3. The screw driver claimed in claim 1 wherein said ejector includes a magnetic member for bit retraction into said bit storage means.

4. The screw driver claimed in claim 1 wherein said bit storage means is a cylinder.

5. The screw driver claimed in claim 4 wherein said cylinder includes magnetic bit retention means.

6. The screw driver claimed in claim 1 wherein said hand grip is swingably mounted on said base and has multiple positions during screw driver use, a limit stop on said hand grip limiting ejector movement in one direction.

7. The screw driver claimed in claim 1 wherein said drive means includes a pawl and a ratchet wheel, the latter in place on said drive tube, said pawl positionable relative the ratchet wheel for imparting clockwise and counterclockwise rotation to the drive tube.

8. A screw driver with multiple bit storage comprising,
a main body,
bit storage means for an array of bits for driving headed fasteners,
means on said main body movably mounting said bit storage means on said main body,
an ejector carried by said main body for displacing a bit from said bit storage means upon axial alignment of bit and ejector,
a drive tube for reception of a bit ejected to position the bit in an exposed manner, and
drive means for imparting rotation to the drive tube and a bit carried thereby upon arcuate movement of said main body about the drive tube axis.

9. The screw driver with multiple bit storage as claimed in claim 8 wherein said ejector includes a magnetic member.

10. The screw driver with multiple bit storage means as claimed in claim 8 wherein said bit storage means includes bit retention means.

11. The screw driver with multiple bit storage means as claimed in claim 8 wherein said bit storage means is of cylindrical shape.
